(19) United States
(12) Patent Application Publication
(10) Pub. No.: US 2014/0043316 A1
(43) Pub. Date: Feb. 13, 2014

(54) SYSTEM AND METHODS FOR POWER CONSERVATION FOR AMOLED PIXEL DRIVERS

(71) Applicant: Ignis Innovation Inc., Waterloo (CA)

(72) Inventors: Gholamreza Chaji, Waterloo (CA); Jaimal Soni, Waterloo (CA)

(73) Assignee: Ignis Innovation Inc., Waterloo (CA)

(21) Appl. No.: 14/058,623

(22) Filed: Oct. 21, 2013

Related U.S. Application Data
(63) Continuation of application No. 12/958,938, filed on Dec. 2, 2010.

(30) Foreign Application Priority Data
Dec. 6, 2009 (CA) 2687631

(51) Int. Cl. G09G 3/32

(52) U.S. Cl. CPC G09G 3/3258
USPC 345/212; 345/76

(57) ABSTRACT

A system is provided for conserving energy in an AMOLED display having pixels that include a drive transistor and an organic light emitting device, and an adjustable source of a supply voltage for the drive transistor. The system monitors the content of a selected segment of the display, sets the supply voltage to the minimum supply voltage required for the current content of the selected segment of the display, determines whether the number of pixels requiring a supply voltage larger than the set value is greater than a predetermined threshold number, and, when the answer is negative, reduces the supply voltage by a predetermined step amount.

### CROSS-REFERENCE TO RELATED APPLICATION

This application is a continuation-in-part of, and claims priority to, pending U.S. patent application Ser. No. 12/958,938, filed Dec. 2, 2010, entitled “Systems and Methods for Power Conservation for AMOLED Pixel Drivers,” which in turn claims the benefit of Canadian Patent Application Serial No. 2,687,631, filed Dec. 6, 2009, entitled “Low Power Driving Scheme For Display Applications,” which are incorporated herein by reference in their entirety.

### FIELD OF THE INVENTION

The present invention generally relates to AMOLED displays, and particularly conserving power consumption on such displays for certain high brightness conditions.

### BACKGROUND

Currently, active matrix organic light emitting device (“AMOLED) displays are being proposed. The advantages of such displays include lower power consumption, manufacturing flexibility and faster refresh rate. In contrast to conventional LCD displays, there is no backlighting in an AMOLED display, and each pixel consists of different OLEDs, emitting light independently. The power consumed in each pixel has a relation with the magnitude of the generated light in that pixel. A typical pixel includes the organic light emitting device and a thin film drive transistor. A programming voltage is applied to the gate of the drive transistor which is roughly proportional to the current flowing through the drive transistor to the light emitting device. However, the use of current makes the performance of the pixel dependent on the drive transistor whose characteristics may change since many such transistors are currently fabricated from amorphous silicon. For example, the threshold voltage of amorphous silicon transistors may shift over long term use resulting in data from the programming voltage being incorrectly applied due to the shift.

While the active matrix organic light emitting diode (AMOLED) display is well-known for its low average power consumption, power consumption may still be higher than an active matrix liquid crystal display (AMLCD) at peak brightness. This makes an AMOLED display less appealing for applications such as emails, web surfing and eBooks due to the largely white (high brightness) background required to display such applications. The power dissipation in the AMOLED display is governed by that associated with the thin film drive transistor and the OLED itself. Although the development of a higher efficiency OLED continues to significantly lower the power consumption of the display, the power consumption of current OLED displays in applications requiring high brightness are greater than a comparable AMLCD. New approaches in TFT operation are therefore needed for further reduction in power. Thus a method to reduce power consumption to compensate for increased power requirements in certain brightness conditions is needed.

### SUMMARY

Aspects of the present disclosure include a current-biased, voltage-programmed circuit for a pixel of a display. The circuit includes a controllable supply voltage source outputting a supply voltage. An organic light emitting device emitting light has a brightness level as a function of current flow. A drive transistor has a drain coupled to the controllable supply voltage source and a source coupled to the organic light emitting device. The drive transistor has a gate input controlled by a programming voltage input to determine the current flow through the light emitting device. To conserve energy, the system monitors the content of a selected segment of the display, sets the supply voltage to the minimum supply voltage required for the current content of the selected segment of the display, determines whether the number of pixels requiring a supply voltage larger than the set value is greater than a predetermined threshold number, and, when the answer is negative, reduces the supply voltage by a predetermined step amount.

The foregoing and additional aspects and embodiments of the present invention will be apparent to those of ordinary skill in the art in view of the detailed description of various embodiments and/or aspects, which is made with reference to the drawings, a brief description of which is provided next.

### BRIEF DESCRIPTION OF THE DRAWINGS

The foregoing and other advantages of the invention will become apparent upon reading the following detailed description and upon reference to the drawings.

FIG. 1 is a block diagram of an AMOLED display;

FIG. 2 is a block diagram of a pixel driver circuit for the AMOLED display in FIG. 1;

FIG. 3 is a graph of voltage levels for different modes for power consumption savings for the pixel driver circuit in FIG. 2;

FIG. 4 is an alternate pixel driver circuit that may use the power consumption control while controlling for voltage drop and preventing threshold voltage shift;

FIG. 5 is a timing diagram for the control and data signals for the driver circuit in FIG. 4; and

FIG. 6 is a power consumption graph of the example driver circuit against a conventional AMOLED display for different graphics images.

FIG. 7 is a diagrammatic illustration of the sources of power dissipation in an electroluminescent display.

FIG. 8 is a flowchart of a technique for adjusting the supply voltage for a pixel circuit based on the content of a selected segment of a display and a predetermined threshold value.

FIG. 9 is a flow chart of an algorithm for finding the value of the minimum supply voltage for the content of a selected segment of a display.

FIG. 10 is a flow chart of a procedure for compensating for the supply voltage variation in respect to other compensation factors.

FIG. 11 is a flow chart of a modified procedure that compensates for supply voltage variations using effect matrices.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

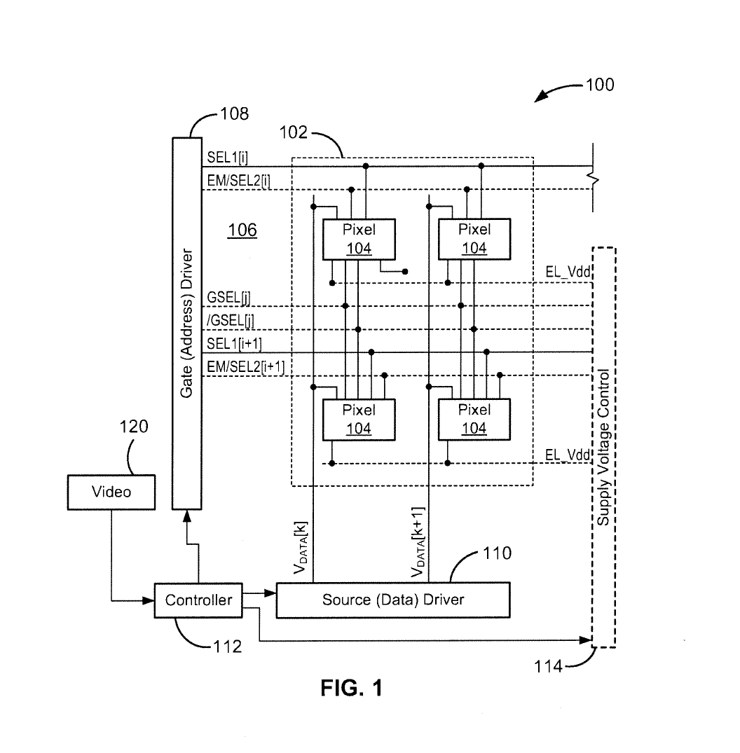

FIG. 1 is an electronic display system 100 having an active matrix area or pixel array 102 in which an array of pixels 104 are arranged in a row and column configuration. For ease of illustration, only two rows and columns are shown. External to the active matrix area of the pixel array 102 is a peripheral area 106 where peripheral circuitry for driving and controlling the pixel array 102 are disposed. The peripheral circuitry includes a gate or address driver circuit 108, a source or data driver circuit 110, a controller 112, and a supply voltage (e.g., Vdd) driver 114. The controller 112 controls the gate, source, and supply voltage drivers 108, 110, 114. The gate driver 108, under control of the controller 112, operates on address or select lines SEL[i], SEL[i+1], and so forth, one for each row of pixels 104 in the pixel array 102. A video source 120 feeds processed video data into the controller 112 for display on the display system 100. The video source 120 represents any video output from devices using the display system 100 such as a computer, cell phone, PDA and the like. The controller 112 converts the processed video data to the appropriate voltage programming information to the pixels 104 on the display 100 system 100.

In pixel sharing configurations described below, the gate or address driver circuit 108 can also optionally operate on global select lines GSEL[j] and optionally/GSEL[j], which operate on multiple rows of pixels 104 in the pixel array 102, such as every two rows of pixels 104. The source driver circuit 110, under control of the controller 112, operates on voltage data lines Vdata[k], Vdata[k+1], and so forth, one for each column of pixels 104 in the pixel array 102. The voltage data lines carry voltage programming information to each pixel 104 indicative of a brightness of each light emitting device in the pixel 104. A storage element, such as a capacitor, in each pixel 104 stores the voltage programming information until an emission or driving cycle turns on the light emitting device. The supply voltage driver 114, under control of the controller 112, controls the level of voltage on a supply voltage (EL_Vdd) line, one for each row of pixels 104 in the pixel array 102. Alternatively, the voltage driver 114 may individually control the level of supply voltage for each row of pixels 104 in the pixel array 102 or each column of pixels 104 in the pixel array 102. As will be explained, the level of the supply voltage is adjusted to conserve power consumed by the pixel array 102 depending on the brightness required.

As is known, each pixel 104 in the display system 100 needs to be programmed with information indicating the brightness of the organic light emitting device in the pixel 104 for a particular frame. A frame defines the time period that includes a programming cycle or phase during which each and every pixel in the display system 100 is programmed with a programming voltage indicative of a brightness and a driving or emission cycle or phase during which each light emitting device in each pixel is turned on to emit light at a brightness commensurate with the programming voltage stored in a storage element. A frame is thus one of many still images that compose a complete moving picture displayed on the display system 100. There are at least two schemes for programming and driving the pixels: row-by-row, or frame-by-frame. In row-by-row programming, a row of pixels is programmed and then driven before the next row of pixels is programmed and driven. In frame-by-frame programming, all rows of pixels in the display system 100 are programmed first, and all of the pixels are driven row-by-row. Either scheme can employ a brief vertical blanking time at the beginning or end of each frame during which the pixels are neither programmed nor driven.

The components located outside of the pixel array 102 can be disposed in a peripheral area 106 around the pixel array 102 on the same physical substrate on which the pixel array 102 is disposed. These components include the gate driver 108, the source driver 110 and the supply voltage controller 114. Alternatively, some of the components in the peripheral area can be disposed on the same substrate as the pixel array 102 while other components are disposed on a different substrate, or all of the components in the peripheral area can be disposed on a substrate different from the substrate on which the pixel array 102 is disposed. Together, the gate driver 108, the source driver 110, and the supply voltage control 114 make up a display driver circuit. The display driver circuit in some configurations can include the gate driver 108 and the source driver 110 but not the supply voltage controller 114.

The use of the AMOLED display system 100 in FIG. 1 for applications with bright backgrounds such as emails, Internet surfing, etc. requires higher power consumption due to the need for each pixel to serve as a light for such applications. However, the same supply voltage applied to the drive transistors of each pixel is still used when the pixel is switched to varying degrees of gray scales (brightness). The current example therefore manages the supply power of the drive transistors for video data that requires higher brightness, therefore resulting in power savings while maintaining the necessary luminescence compared to an ordinary AMOLED display with a constant supply voltage to the drive transistors.

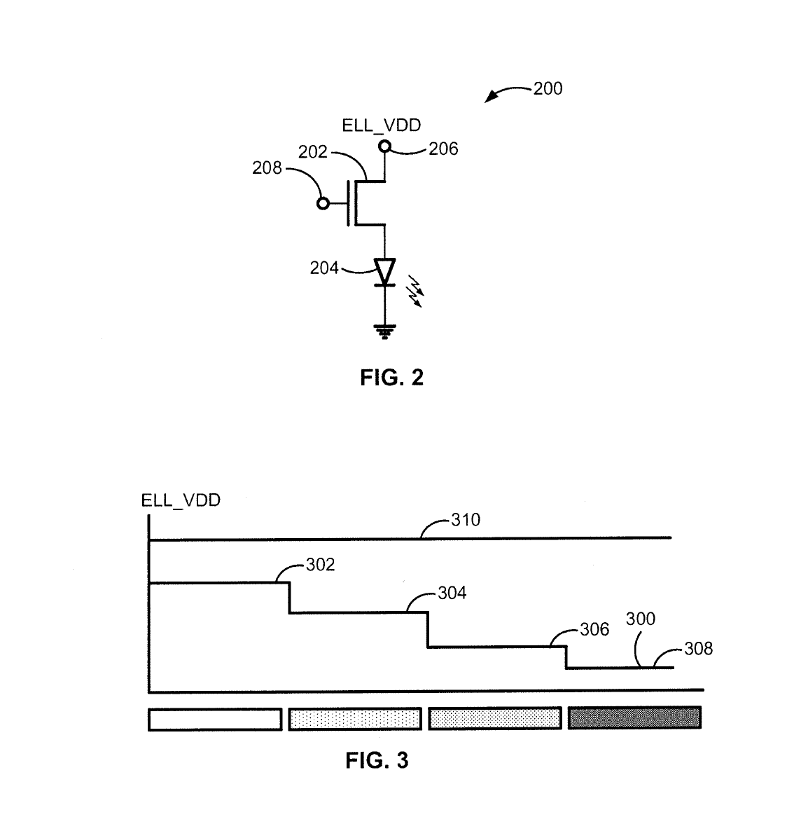

FIG. 2 is a circuit diagram of a simple individual driver circuit 200 for a pixel such as the pixel 104 in FIG. 1. As explained above, each pixel 104 in the pixel array 102 in FIG. 1 is driven by the driver circuit 200 in FIG. 2. The driver circuit 200 includes a drive transistor 202 coupled to an organic light emitting device 204. In this example, the organic light emitting device 204 is a luminous organic material which is activated by current flow and whose brightness is a function of the magnitude of the current. A supply voltage input 206 is coupled to the drain of the drive transistor 202. The supply voltage input 206 in conjunction with the drive transistor 202 creates current in the light emitting device 204. The current level may be controlled via a programming voltage input 208 coupled to the gate of the drive transistor 202. The programming voltage input 208 is therefore coupled to the source driver 110 in FIG. 1. In this example, the drive transistor 202 is a thin film transistor fabricated from hydrogenated amorphous silicon. Of course, the techniques described herein may be employed with drive transistors fabricated from other semi-conductor materials. Other circuit components such as capacitors and transistors (not shown) may be added to the simple driver circuit 200 to allow the pixel to operate with various enable, select and control signals such as those input by the gate driver 108 in FIG. 1. Such components are used for faster programming of the pixels, holding the programming of the pixel during different frames and other functions.

When the pixel 104 is required to have maximum brightness such as in applications such as e-mail or web surfing, the gate of the drive transistor 202 is driven so the transistor 202 is in saturation mode and therefore fully open allowing high current to flow through the organic light emitting device 204 creating maximum brightness. Lower levels of brightness for the light emitting device 204, such as those for lower gray scales, are controlled by controlling the voltage to the gate of the drive transistor 202 in the linear region. When the drive transistor 202 operate in this region, the gate voltage controls the current supplied to the light emitting device 204 linearly and therefore the brightness of the light emitting device. In a power saving mode in this example, the power consumption associated with the drive transistor 202 is reduced because as the drive transistor 202 is driven into saturation mode at a certain threshold voltage, a lower supply voltage above the threshold voltage will still maintain a level of current to the light emitting device 204 that produces roughly the same brightness as a higher supply voltage would.

FIG. 3 shows four different modes of power consumption that regulate the supply voltage level 300. A first mode has a relatively high driver voltage level 302 which results in the highest brightness. A second mode has a relatively lower voltage level 304 as the pixel is not required to be as bright such as a gray scale requiring a region to allow sufficient gate voltage control of the necessary brightness. A third mode has a lower voltage level 306 resulting in a darker shade. A fourth mode reduces the driver voltage to a low level 308. A constant supply voltage level 310 represents a conventional AMOLED driver circuit where the supply voltage is kept at one level. The varying of supply voltages to the drive transistor depending on the brightness requirements of the pixel 104 results in savings in power consumption of around 40% over a conventional OLED pixel represented by the voltage level 310. It is to be understood that there may be any number of different power supply levels.

The level of the supply voltage from the supply voltage input 206 in FIG. 2 is controlled by the voltage controller 114 in FIG. 1. The control of the supply voltage may be based on the current required by the display system 100 based on sensed display current compared to certain threshold levels. One example of measuring display current is determining the total current from the power supply connected to the display system 100. In this example, the controller 112 will compare the sensed display current with threshold levels and adjust the supply voltages supplied by the voltage controller 114 to save power consumption as the different threshold levels are exceeded. A higher current may indicate that the supply voltages may be lowered to a level that still achieves the needed brightness. A lower current will allow lower voltages to be used in situations where the pixel is largely in darker gray scales not requiring bright levels.

Alternatively, the determination may be made during video processing based on the amount of overall brightness required in a particular video frame based on the video data received from the video source 120 in FIG. 1. Such a determination could be made via video processing software on the device associated with the video source 120 using the display system 100 in FIG. 1 or by the controller 112. For example, in the cases of a smooth gradient image (gradual transition from black to full white), if the gradient stays the same between frames with no sudden jumps, contouring effects or color shifts, the controller 112 may determine that the image quality is not changed and adjustments may be made to the supply voltage. In this example, the supply voltage is controlled at the same level for each pixel in the display 100 via a common voltage supply line. However, different segments of pixels may have their supply voltages controlled independently such as the supply voltages for each row of pixels or column of pixels for more precise power saving. The independent voltage control for the drive transistors of different segments of pixels may be preferably performed for larger displays having more variation of brightness levels for a given frame over the different pixels.

The drive transistor 202 has a saturation region where current is constant against the voltage applied across the source and the drain such as the supply voltage from the supply voltage input 206 in FIG. 2. At lower gate voltage levels, the level of current through the transistor has a linear relationship with the gate voltage. A transition region exists between the linear region and the saturation region. The saturation region maintains a substantially constant current for any voltage level above the threshold voltage. Operating in saturation has been necessary due to the high contact resistance associated with an amorphous silicon thin film transistor such as the drive transistor 202 in particular.

Thus, the operating voltage for a pixel should be chosen such that the drive transistor 202 stays in deep saturation to reduce cross talk stemming from voltage drop on the supply voltage input 206 in a power saving mode. The pixel 104 is therefore programmed with a high current to the light emitting device 204 therefore making it become an almost linear function of the voltage across the drive transistor 202. In this case, the high current required for the light emitting device 204 effectively leads to source degeneration, thus reducing the effect of the voltage drop on the drive transistor 202. Also, during the leakage time, the pixel current is brought to normal levels, which further compensates for the voltage drop. As a result the display luminance stays the same. This effect reduces the power of the drive transistor 202 by over 50% and total power consumption by 40% when the pixel 104 is at the highest brightness levels required for applications such as e-mail and web browsing.

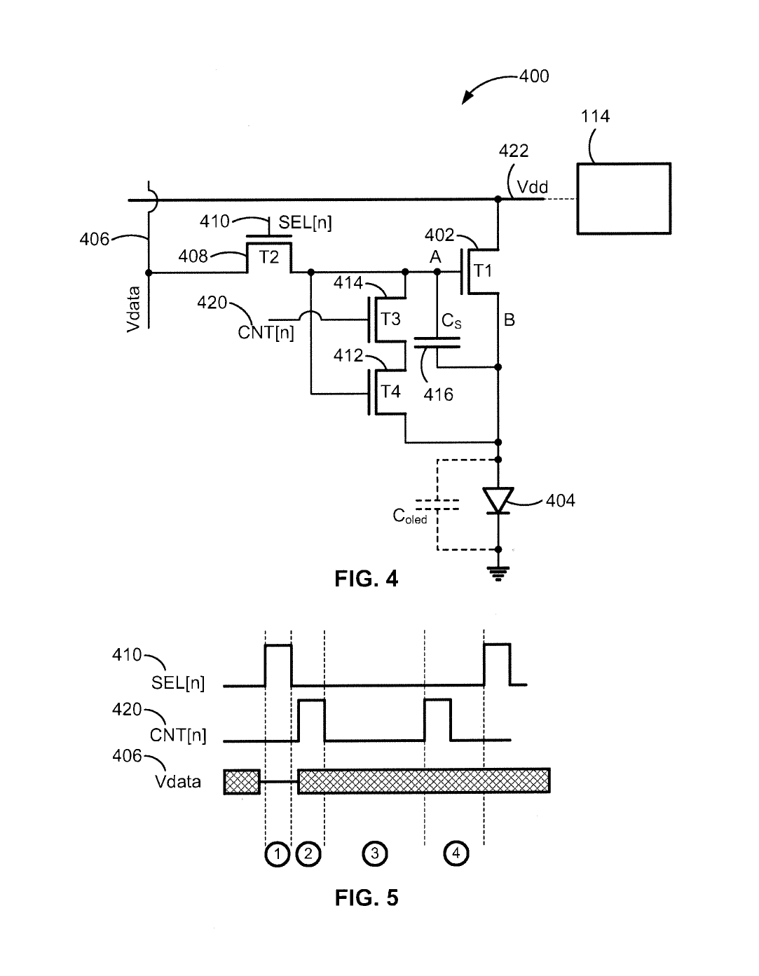

However, since the drive transistor 202 is shifted toward the linear region of operation by lower supply voltages in order to maintain the necessary high current for the light emitting device 204, the image quality is affected by ground bouncing and voltage drop. However, since the gray scales are further apart in applications requiring primarily bright pixels such as e-mail, the image quality will not be affected significantly. In order to maintain the same luminance, the programming voltage input to the gate of the drive transistor 202 may be controlled by adjusting gamma curves. FIG. 4 shows an alternate driver circuit 400 for a display pixel such as the pixels 104 in FIG. 1 that may employ the voltage supply control but tolerate voltage drop and ground bouncing. The driver circuit 400 is capable of operating in the saturation-linear transition region or even further down in the linear region of the driver transistor, resulting in significant power reduction without causing any image artifacts.

The driver circuit 400 includes a drive transistor 402 having a source coupled to an organic light emitting device 404. A programming voltage input 406 is coupled to the gate of the drive transistor 402 through a select transistor 408. The select transistor 408 has a gate that is coupled to a select input 410. A select signal on the select input 410 allows a programming voltage signal on the program voltage input 406 to adjust the current through the drive transistor 402 to the light emitting device 404. The program voltage input 406 is coupled to the drain of the select transistor 406. The source of the select transistor 408 is coupled to the gate of the drive transistor 402 and the gate of a bias transistor 412 that is wired in series to another bias transistor 414. A source capacitor 416 is charged to the programming voltage when the select transistor 408 is turned on. A control signal input 420 is coupled to the gate of the bias transistor 414. A controlled supply voltage input 422 is coupled to the drain of the drive transistor 402. The input supply voltage 422 is controlled via a voltage controller such as the voltage controller 114 in FIG. 1 to adjust the supply voltage level and therefore save power for the driver circuit 400.

FIG. 5 is a timing diagram of the signals for the select input 410, the control input 420 and the programming input 406 in FIG. 4 during one frame of the pixel powered by the driver circuit 400. When the select signal on the signal input 410 is input to the select transistor 408, the transistor 408 is turned on allowing the programming voltage signal input 406 to charge the source capacitor 416 to the programming voltage level that will produce the proper current flow through the drive transistor 402 to the organic light emitting device 404. This part of the cycle programs the pixel circuit 400 with the proper brightness level based on the programming voltage signal input 406. The voltage drop and ground bouncing are eliminated by the use of the bias transistors 412 and 414.

As shown in FIG. 5, the next part of the cycle turns off the select signal on the signal input 410 and turns on the control signal to the control signal input 420 coupled to the gate of the transistor 414. When the select signal on the select signal input 410 is strobed low, the select transistor 408 is turned off causing the programming voltage to be held by the stored voltage in the capacitor 416. The control signal input 420 turns on the bias transistor 414 on. The control signal on the control signal input 420 thus enables voltage compensation with charge leakage. In the next cycle, the control signal on the control signal input 420 is then strobed low which turns off the transistor 414 causing the programming voltage stored on the capacitor 416 to be coupled between the source and the gate of the drive transistor 402. The data programming voltage to the gate causes the current to the light emitting device 404 to be regulated by the drive transistor 402. The pixel is therefore turned on during this period and holds the program voltage level from the programming voltage input 106. The control signal to the control signal input 420 then goes high again which turns the pixel off and therefore relaxes the current flowing through the drive transistor 402. Because of the negative bias caused by the bias transistors 412 and 414, the transistor 402 thus recovers a significant part of the threshold voltage shift and thereby lengthens the life of the transistor 402.

The display circuit 400 in FIG. 4 is therefore off for a small part of the frame time when the control signal input 420 is strobed a second time. Since the circuit 400 is not on for most of the frame time, during the off period, the threshold voltage shift may be recovered. While the circuit is off, the drive transistor 402 is stressed with a high current level via the supply voltage signal 422. The cycle evens the threshold voltage shift of all the pixels in the display thereby reducing the effect of differential aging. The drive transistor 402 is negatively biased during the recovery period, thereby recovering a significant part of the threshold voltage shift serving to prolong the lifetime of the drive transistor 402 and therefore the pixel. This reduces the threshold voltage of the drive transistor 402 by nearly a factor of 3. The driver circuit 400 in FIG. 4 therefore allows the use of lower supply voltage to the drive transistor 402 while compensating for the effects of voltage drop and cross talk.

The driver circuit 400 in FIG. 4 also allows the compensation for voltage shifts in the threshold voltage of the drive transistor 402 due to oversaturation from the lower drive voltage levels. When a lower voltage is applied across the drive transistor 402, it may result in higher voltage threshold shift stemming from increased carriers of the channel which in turn leads to faster aging of the transistor 402. Since the voltages in FIG. 4 are relatively higher due to the bias transistor pair 412 and 414, the drive transistor 402 is not driven in transition for as much time as using a relative lower voltage therefore stabilizing long term threshold voltage shift and increasing the lifetime of the transistor 402.

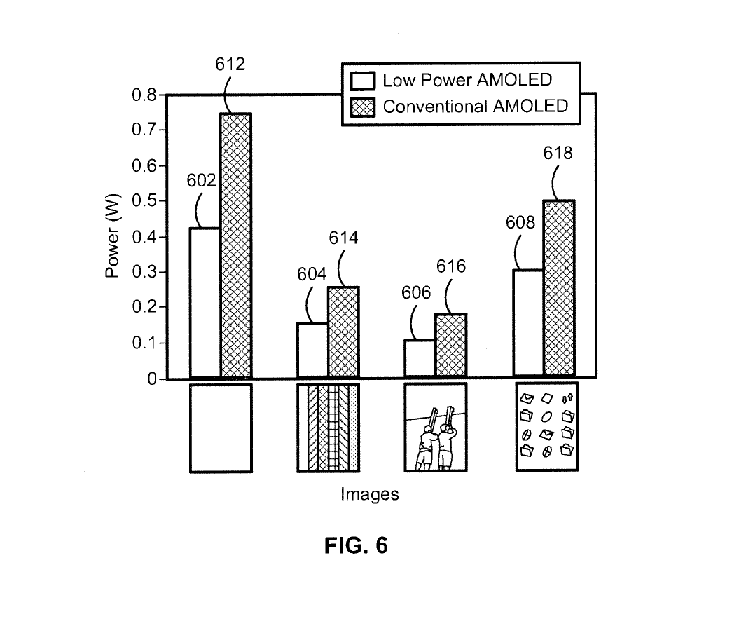

FIG. 6 is a graph showing the savings in power of an AMOLED pixel display using adjustable supply voltage control in comparison with a standard AMOLED pixel display using a constant supply voltage. Significant power savings may be made in applications with high brightness output. A bar 602 shows the lower power level from an AMOLED display using the procedures outlined above in comparison to a bar 612 from a standard AMOLED display when displaying a total white screen. Other applications such as a bright image (e.g., start menu) as represented by the bar 608 showing the lower power consumption of an adjustable supply voltage AMOLED display in comparison to a bar 618 showing the power consumption of a standard AMOLED display. Bars 604 and 606 show the smaller power savings in cases where the pixels are darker (less bright) in comparison to bars 614 and 616 representing the power consumed by a conventional AMOLED display.

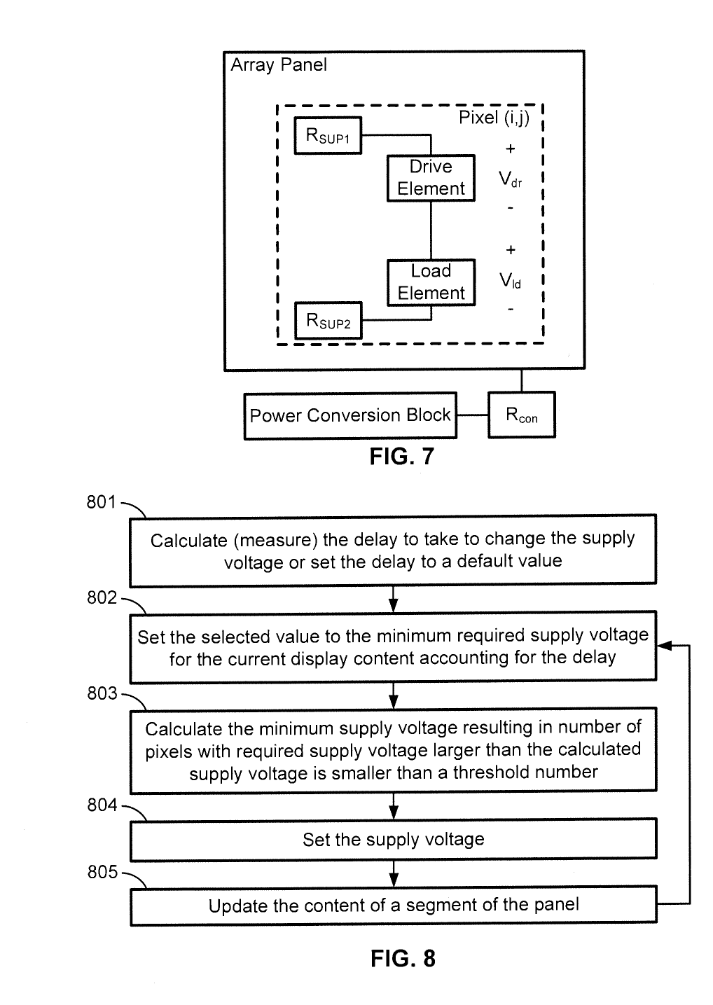

FIG. 7 is a diagrammatic illustration of the sources of power dissipation in an electroluminescent display. As shown, the sources of power consumption are the parasitic resistance (contact:R_{con}, line resistance: Rₛᵤₚ₁ and Rₛᵤₚ₂), and the voltage drops across the drive element and load element. The power consumption can be reduced by improving the load efficiency to operate at lower voltage and lower current levels, and by improving the performance of the drive element to reduce the operation voltage. Also, the driving conditions can be optimized to require only the lowest possible power for any given devices.

In most displays, the supply voltage is adjusted to the worst case, which includes the worst voltage drop across the parasitic resistance plus the worst voltage drop across the drive element and load element. The supply voltage may be adjusted based on the content of the display. In this case, the supply voltage is adjusted based on long hysteresis curves to eliminate any sudden change in the display. Therefore, it does not work effectively when displaying dynamic content (e.g., videos).

FIG. 8 is a flowchart of one implementation of a technique for adjusting the supply voltage based on the content of a segment of the display and a threshold value. This technique eliminates the need for hysteresis curves. The supply voltage is adjusted prior to or after updating a small segment of the display. Since the change in the content of the display segment is minimal during these adjustments, the change in supply voltage is gradual. Thus, sudden changes in the voltages are avoided.

At step 801 in FIG. 8, the delay required to change the supply voltage is calculated or measured, or the delay may be set to a default value. Then at step 802 the supply voltage is set to the minimum voltage required for the current content of the display segment, accounting for the delay. Step 803 calculates the minimum supply voltage that results in a number of pixels having a required supply voltage larger than the set value, that is smaller than a predetermined threshold number. The supply voltage is then set at the calculated value at step 804, and the content of the display segment is updated at step 805.

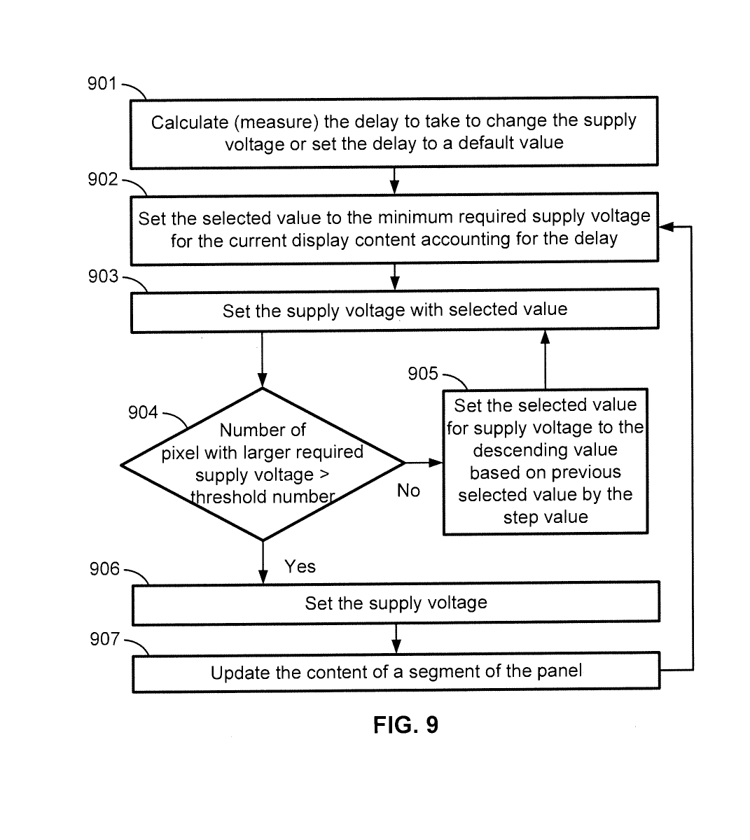

FIG. 9 is a flow chart of a detailed implementation of an algorithm for finding the value of the minimum supply voltage used in step 803 in FIG. 8. In FIG. 9, the first two steps 901 and 902 are the same as the first two steps 801 and 802 in FIG. 8. Then at step 903 the supply voltage is set to a selected value, after which step 904 determines whether the number of pixels requiring a supply voltage larger than the set value, is greater than a predetermined threshold number. The threshold number used in step 904 is defined as the number of pixels that can operate with a supply voltage smaller than the required supply voltage without substantially affecting the image quality. If the answer at step 904 is negative, step 905 reduces the set value of the supply voltage by a predetermined step amount. This enables the display to operate at lower supply voltages, since the number of pixels that require a high supply voltage, based on the image content, is typically a small number in any given image (or frame), and the step to the next lower supply voltage is large. If the answer at step 904 is positive, step 906 sets the actual supply voltage to the value selected in step 902, and then the content of the display segment is updated at step 907.

In a further embodiment, the drive element is pushed to operate in a linear regime where the drive element is sensitive to the supply voltage variation. This mode can be used for cases where the image content is limited (e.g., only few gray levels). However, the use of this operation can be extended by compensating for the supply voltage variation across the panel. Compensation for other factors of the display, such as non-uniformity or aging, should be considered since they can affect the supply voltage variation significantly. There are different techniques for extracting voltage variation across a display, and two of these techniques will be described in accordance with other compensation factors. These two techniques can be swapped with other techniques.

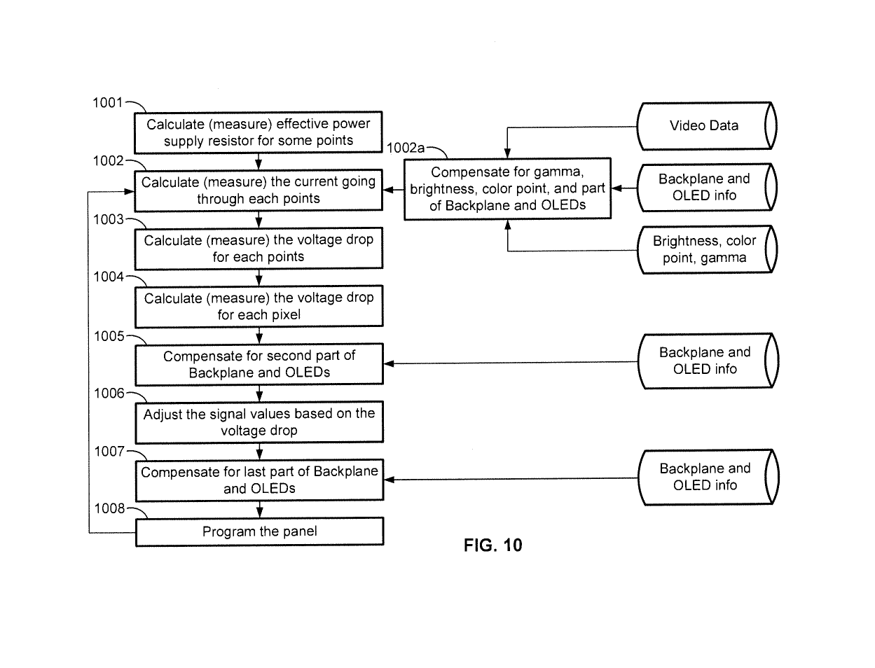

FIG. 10 is a flow chart of a procedure for compensating for the supply voltage variation in respect to other compensation factors. Here, the effective resistance for a few virtual (or physical) points in the display is calculated at step 1001. The video signal is compensated for cases that can directly affect the pixel current, such as gamma, brightness, color point, and efficiency compensation of the load element, at step 1002a, and the current passing through each of the selected points is calculated at step 1002. Using the effective resistance of each point, the voltage drop for each point is then calculated and used to calculate the cumulative voltage drop for each point at step 1003. Using the extracted voltage drop, the effective voltage drop for each pixel is calculated at step 1004, using a different method such as interpolation.

Step 1005 compensates for the supply voltage variation and other compensation factors (e.g., the second part of the backplane and OLED's). Here, the order of compensation factors can be based on reducing the computation error and reducing the complexity of the calculation. The signal values are adjusted at step 1006, based on the pixel voltage drop. Step 1007 compensates for the last part of the backplane and OLED's), and then the display panel is programmed at step 1008.

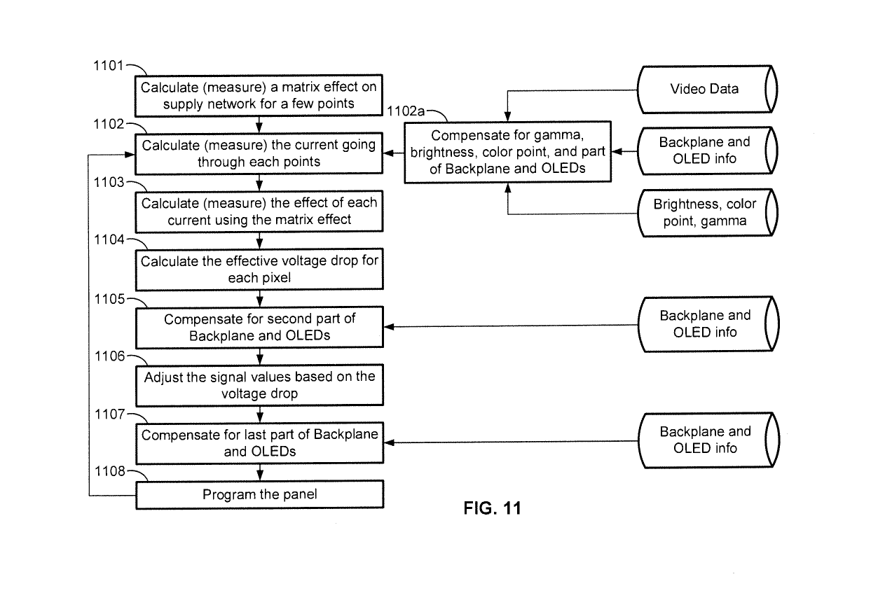

FIG. 11 is a flow chart of a modified embodiment that compensates for supply voltage variations using effect matrices. The effect matrix is measured or calculated for each point at step 1101. This matrix shows the effect of the current passing through the point, on the supply voltage of other points. Thus, the calculation of the supply voltage variation is carried out using the effect matrices, by calculating the current going through each point (step 1102), calculating the effect of each current using the matrix effect (step 1103), and calculating the effective voltage drop for each pixel step 1104). Then the same compensating, adjusting and programming steps described above are executed at steps 1105 through 1107.

While particular embodiments and applications of the present invention have been illustrated and described, it is to be understood that the invention is not limited to the precise construction and compositions disclosed herein and that various modifications, changes, and variations can be apparent from the foregoing descriptions without departing from the spirit and scope of the invention as defined in the appended claims.

What is claimed is:

1. A method of conserving energy in an AMOLED display having pixels that include a drive transistor and an organic light emitting device, and an adjustable source of a supply voltage for the drive transistor, the method comprising
monitoring the content of a selected segment of the display,
setting the supply voltage to the minimum supply voltage required for the current content of said selected segment of the display, and
determining whether the number of pixels in said selected segment that require a supply voltage larger than the set value is greater than a predetermined threshold number and, when the answer is negative, reducing the supply voltage by a predetermined step amount,

2. The method of claim 1 in which said monitoring of said content of said selected segment of the display comprises monitoring the voltage supplied to the gate input of said drive transistor input.

3. An active matrix organic light emitting device display, comprising:
an adjustable supply voltage source;
a plurality of pixels, each coupled to the adjustable supply voltage source, each pixel including:
an organic light emitting device;
a drive transistor having a source and a drain, one of which is coupled to the organic light emitting device and the other of which is coupled to the adjustable supply voltage source;
a plurality of programming voltage inputs coupled to the gates of the drive transistors of the plurality of pixels, the programming voltage inputs providing a programming voltage indicative of a desired brightness of each of the plurality of pixels; and
a supply voltage controller coupled to the adjustable voltage source to regulate the level of a supply voltage supplied to each of the drive transistors, the supply voltage controller
monitoring the content of a selected segment of the display,
setting the supply voltage to the minimum supply voltage required for the current content of said selected segment of the display, and
reducing the supply voltage by a predetermined step amount when the number of pixels in the selected segment that require a supply voltage larger than the set value, is greater than a predetermined threshold number.

4. The active matrix organic light emitting device display of claim 3 in which said content of said selected segment of the display is monitored by monitoring the voltage supplied to the gate input of said drive transistor input.
